(19) United States
(12) Patent Application Publication
(10) Pub. No.: US 2024/0430053 A1
(43) Pub. Date: Dec. 26, 2024

(54) TRANSMISSION CONFIGURATION INDICATOR FOR DOWNLINK CONTROL INFORMATION

(71) Applicant: QUALCOMM Incorporated, San Diego, CA (US)

(72) Inventors: Mostafa KHOSHNEVISAN, San Diego, CA (US); Yitao CHEN, San Marcos, CA (US); Jing SUN, San Diego, CA (US); Yan ZHOU, San Diego, CA (US); Fang YUAN, Beijing (CN); Xiaoxia ZHANG, San Diego, CA (US); Tao LUO, San Diego, CA (US); Peter GAAL, San Diego, CA (US)

(21) Appl. No.: 18/705,929

(22) PCT Filed: Jan. 27, 2022
(86) PCT No.: PCT/CN22/74176

§ 371 Date: Apr. 29, 2024

(51) Int. Cl. H04L 5/00; H04W 72/23

(52) U.S. Cl. CPC H04L 5/0044; H04W 72/23

(57) ABSTRACT

Various aspects of the present disclosure generally relate to wireless communication. In some aspects, a user equipment (UE) may receive first downlink control information (DCI) having a first transmission configuration indicator (TCI) field that indicates a pair of TCI states to be used after a first time. The UE may receive second DCI having a second TCI field that indicates a selected one or more TCI states, of the pair of TCI states, to be used for a physical downlink shared channel (PDSCH). Numerous other aspects are described.

### FIELD OF THE DISCLOSURE

Aspects of the present disclosure generally relate to wireless communication and to techniques and apparatuses for transmission configuration indicator for downlink control information.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving first downlink control information (DCI) having a first transmission configuration indicator (TCI) field that indicates a pair of TCI states to be used after a first time. The method may include receiving second DCI having a second TCI field that indicates a selected one or more TCI states, of the pair of TCI states, to be used for a physical downlink shared channel (PDSCH).

Some aspects described herein relate to a method of wireless communication performed by a network node. The method may include transmitting first DCI having a first TCI field that indicates a pair of TCI states to be used after a first time. The method may include transmitting second DCI having a second TCI field that indicates a selected one or more TCI states, of the pair of TCI states, to be used for a PDSCH.

Some aspects described herein relate to an apparatus for wireless communication performed by a UE. The apparatus may include a memory and one or more processors, coupled to the memory. The one or more processors may be configured to receive first DCI having a first TCI field that indicates a pair of TCI states to be used after a first time. The one or more processors may be configured to receive second DCI having a second TCI field that indicates a selected one or more TCI states, of the pair of TCI states, to be used for a PDSCH.

Some aspects described herein relate to an apparatus for wireless communication performed by a network node. The apparatus may include a memory and one or more processors, coupled to the memory. The one or more processors may be configured to transmit first DCI having a first TCI field that indicates a pair of TCI states to be used after a first time. The one or more processors may be configured to transmit second DCI having a second TCI field that indicates a selected one or more TCI states, of the pair of TCI states, to be used for a PDSCH.

Some aspects described herein relate to a non-transitory computer-readable medium that stores a set of instructions for wireless communication by a UE. The set of instructions, when executed by one or more processors of the UE, may cause the UE to receive first DCI having a first TCI field that indicates a pair of TCI states to be used after a first time. The set of instructions, when executed by one or more processors of the UE, may cause the UE to receive second DCI having a second TCI field that indicates a selected one or more TCI states, of the pair of TCI states, to be used for a PDSCH.

Some aspects described herein relate to a non-transitory computer-readable medium that stores a set of instructions for wireless communication by a network node. The set of instructions, when executed by one or more processors of the network node, may cause the network node to transmit first DCI having a first TCI field that indicates a pair of TCI states to be used after a first time. The set of instructions, when executed by one or more processors of the network node, may cause the network node to transmit second DCI having a second TCI field that indicates a selected one or more TCI states, of the pair of TCI states, to be used for a PDSCH.

Some aspects described herein relate to an apparatus for wireless communication. The apparatus may include means for receiving first DCI having a first TCI field that indicates a pair of TCI states to be used after a first time. The apparatus may include means for receiving second DCI having a second TCI field that indicates a selected one or more TCI states, of the pair of TCI states, to be used for a PDSCH.

Some aspects described herein relate to an apparatus for wireless communication. The apparatus may include means for transmitting first DCI having a first TCI field that indicates a pair of TCI states to be used after a first time. The apparatus may include means for transmitting second DCI having a second TCI field that indicates a selected one or more TCI states, of the pair of TCI states, to be used for a PDSCH.

Aspects generally include a method, apparatus, system, computer program product, non-transitory computer-readable medium, user equipment, network node, base station, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of communication beams, in accordance with the present disclosure.

FIG. 4 is a diagram illustrating an example of communications using a multiple transmission reception point (TRP) scheme, in accordance with the present disclosure.

FIG. 5 is a diagram illustrating an example of unified transmission configuration indicator (TCI) in a single TRP scheme, in accordance with the present disclosure.

FIG. 6 is a diagram illustrating an example of beam indication downlink control information (DCI) and scheduling DCI, in accordance with the present disclosure.

FIG. 7 is a diagram illustrating an example associated with TCI for DCI, in accordance with the present disclosure.

FIG. 8 is a diagram illustrating a first example associated with TCI state selection, in accordance with the present disclosure.

FIG. 9 is a diagram illustrating a second example associated with TCI state selection, in accordance with the present disclosure.

FIG. 10 is a diagram illustrating a third example associated with TCI state selection, in accordance with the present disclosure.

FIG. 11 is a diagram illustrating a fourth example associated with TCI state selection, in accordance with the present disclosure.

FIG. 12 is a diagram illustrating an example associated with subsequent DCI that schedules the physical downlink shared channel (PDSCH), in accordance with the present disclosure.

FIG. 13 is a diagram illustrating an example process associated with TCI for DCI, in accordance with the present disclosure.

FIG. 14 is a diagram illustrating an example process associated with TCI for DCI, in accordance with the present disclosure.

FIG. 15 is a diagram of an example apparatus for wireless communication, in accordance with the present disclosure.

FIG. 16 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

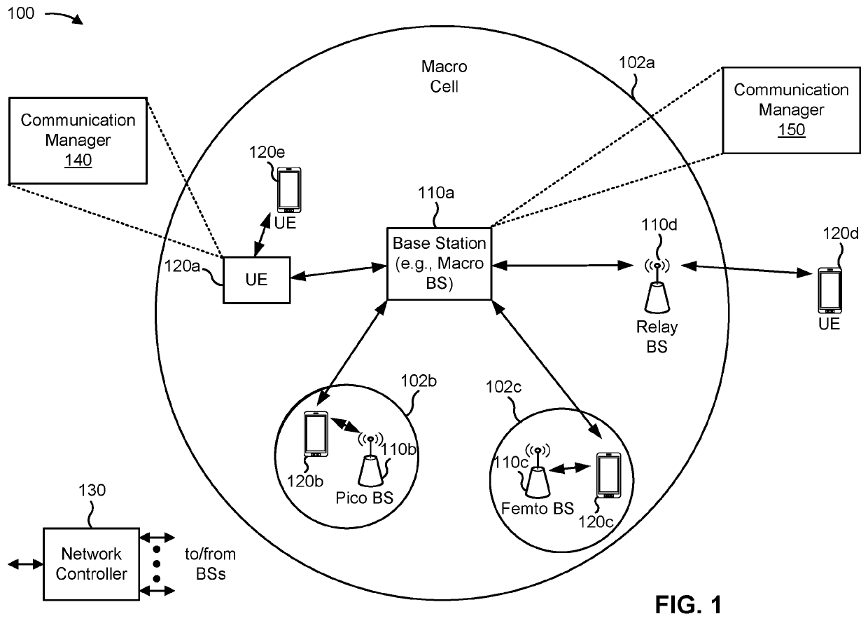

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell. a pico cell. a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some aspects, a node, which may be referred to as a “node,” a “network node,” or a “wireless node,” may be a base station (e.g., base station 110), a UE (e.g., UE 120), a relay device, a network controller, an apparatus, a device, a computing system, one or more components of any of these, and/or another processing entity configured to perform one or more aspects of the techniques described herein. For example, a network node may be a UE. As another example, a network node may be a base station. As an example, a first network node may be configured to communicate with a second network node or a third network node. The adjectives “first,” “second,” “third,” and so on are used for contextual distinction between two or more of the modified noun in connection with a discussion and are not meant to be absolute modifiers that apply only to a certain respective node throughout the entire document. For example, a network node may be referred to as a “first network node” in connection with one discussion and may be referred to as a “second network node” in connection with another discussion, or vice versa. Reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE being configured to receive information from a base station also discloses a first network node being configured to receive information from a second network node, “first network node” may refer to a first UE, a first base station, a first apparatus, a first device, a first computing system, a first one or more components, a first processing entity, or the like configured to receive the information from the second network; and “second network node” may refer to a second UE, a second base station, a second apparatus, a second device, a second computing system, a second one or more components, a second processing entity, or the like.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations. femto base stations. and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example. the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHz). It should be understood that although a portion of FR1 is greater than 6 GHz. FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHZ), FR4 (52.6 GHZ-114.25 GHZ), and FR5 (114.25 GHZ-300 GHz). Each of these higher frequency bands falls within the EHF band.

With the above examples in mind, unless specifically stated otherwise, it should be understood that the term “sub-6 GHZ” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a. FR4-1, and/or FR5) may be modified, and techniques described herein are applicable to those modified frequency ranges.

In some aspects, the UE 120 may include a communication manager 140. As described in more detail elsewhere herein, the communication manager 140 may receive first downlink control information (DCI) having a first transmission configuration indicator (TCI) field that indicates a pair of TCI states to be used after a first time: and receive second DCI having a second TCI field that indicates a selected one or more TCI states, of the pair of TCI states, to be used for a physical downlink shared channel (PDSCH). Additionally, or alternatively, the communication manager 140 may perform one or more other operations described herein.

In some aspects, the network node 705 may include a communication manager 150. As described in more detail elsewhere herein, the communication manager 150 may transmit first DCI having a first TCI field that indicates a pair of TCI states to be used after a first time; and transmit second DCI having a second TCI field that indicates a selected one or more TCI states, of the pair of TCI states, to be used for a PDSCH. Additionally, or alternatively, the communication manager 150 may perform one or more other operations described herein.

As indicated above, FIG. 1 is provided as an example. Other examples may differ from what is described with regard to FIG. 1.

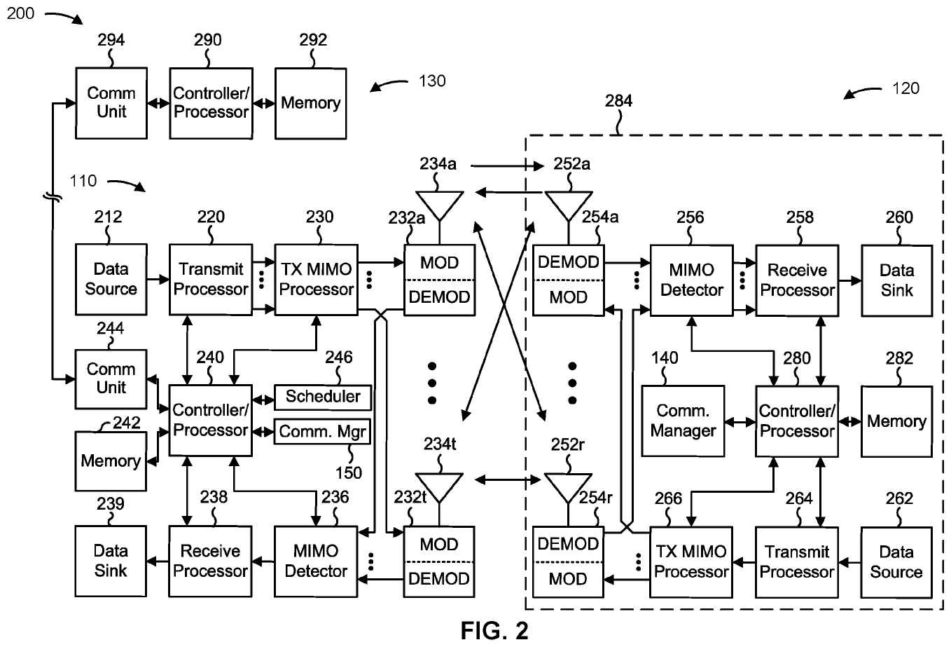

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

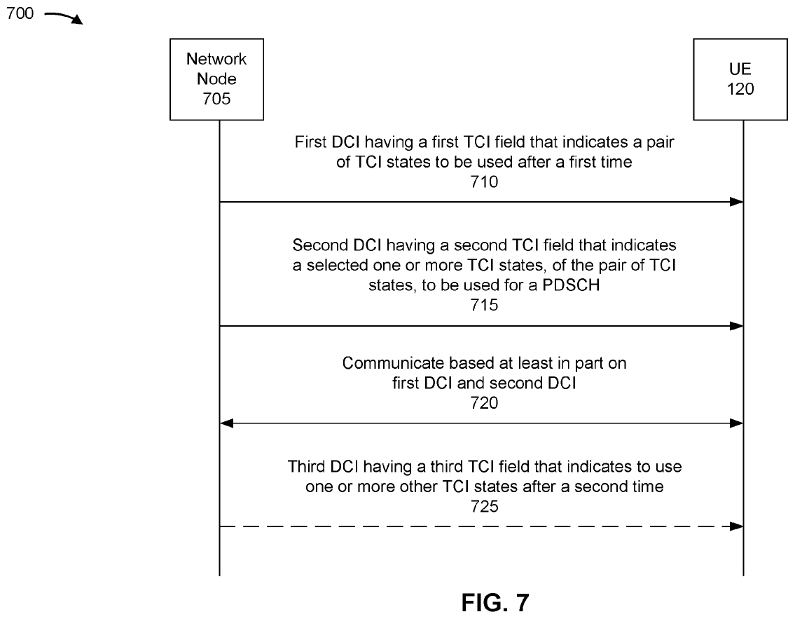

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7-16).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7-16).

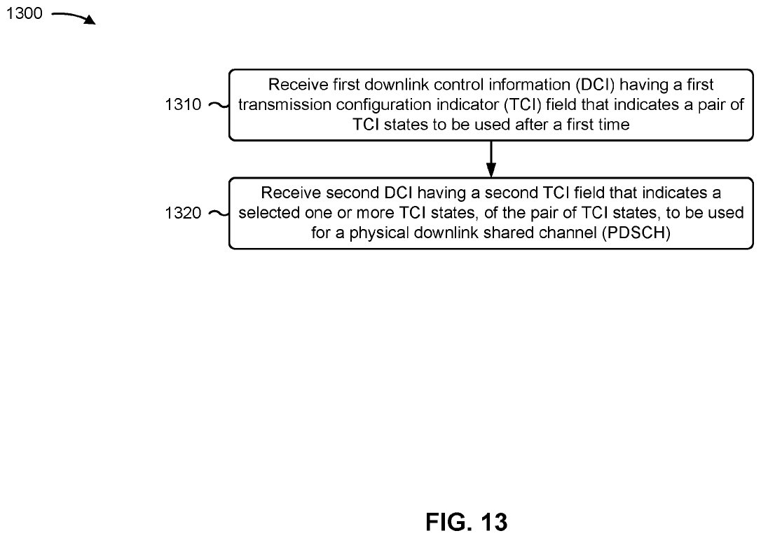

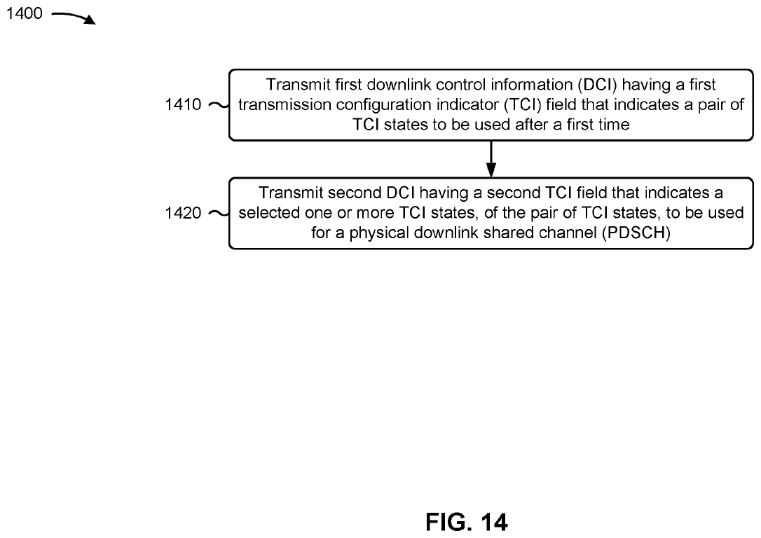

The controller/processor 240 of the base station 110, the controller/processor 280 of the UE 120, and/or any other component(s) of FIG. 2 may perform one or more techniques associated with TCI for DCI, as described in more detail elsewhere herein. For example, the controller/processor 240 of the base station 110, the controller/processor 280 of the UE 120, and/or any other component(s) of FIG. 2 may perform or direct operations of, for example, process 1300 of FIG. 13, process 1400 of FIG. 14, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling. converting, and/or interpreting) by one or more processors of the base station 110 and/or the UE 120, may cause the one or more processors, the UE 120, and/or the base station 110 to perform or direct operations of, for example, process 1300 of FIG. 13, process 1400 of FIG. 14, and/or other processes as described herein. In some examples, executing instructions may include running the instructions, converting the instructions, compiling the instructions, and/or interpreting the instructions, among other examples.

In some aspects, the UE 120 includes means for receiving first DCI having a first TCI field that indicates a pair of TCI states to be used after a first time: and/or means for receiving second DCI having a second TCI field that indicates a selected one or more TCI states, of the pair of TCI states, to be used for a PDSCH. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 705 includes means for transmitting first DCI having a first TCI field that indicates a pair of TCI states to be used after a first time; and/or means for transmitting second DCI having a second TCI field that indicates a selected one or more TCI states, of the pair of TCI states, to be used for a PDSCH. The means for the network node 705 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

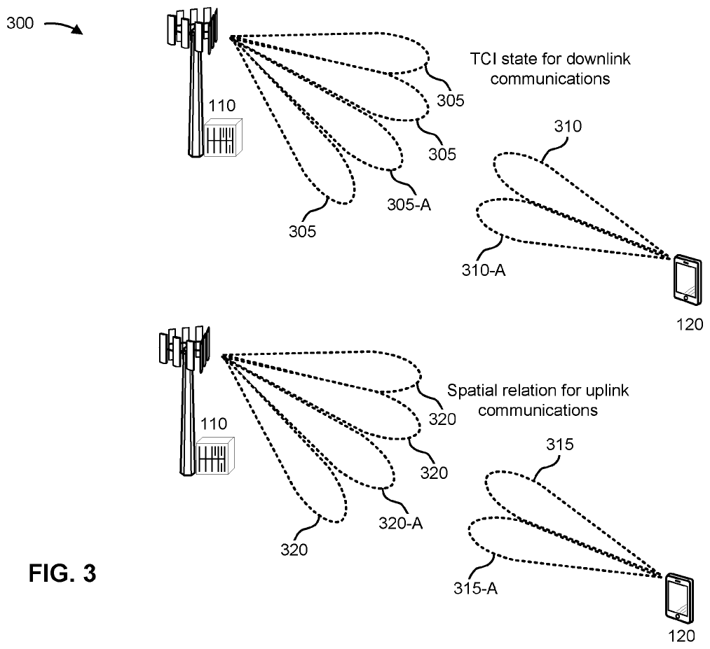

FIG. 3 is a diagram illustrating an example 300 of using beams for communications between a base station and a UE, in accordance with the present disclosure. As shown in FIG. 3, a base station 110 and a UE 120 may communicate with one another.

The base station 110 may transmit to UEs 120 located within a coverage area of the base station 110. The base station 110 and the UE 120 may be configured for beamformed communications, where the base station 110 may transmit in the direction of the UE 120 using a directional BS transmit beam, and the UE 120 may receive the transmission using a directional UE receive beam. Each BS transmit beam may have an associated beam ID, beam direction, or beam symbols, among other examples. The base station 110 may transmit downlink communications via one or more BS transmit beams 305.

The UE 120 may attempt to receive downlink transmissions via one or more UE receive beams 310, which may be configured using different beamforming parameters at receive circuitry of the UE 120. The UE 120 may identify a particular BS transmit beam 305, shown as BS transmit beam 305-A, and a particular UE receive beam 310, shown as UE receive beam 310-A, that provide relatively favorable performance (for example, that have a best channel quality of the different measured combinations of BS transmit beams 305 and UE receive beams 310). In some examples, the UE 120 may transmit an indication of which BS transmit beam 305 is identified by the UE 120 as a preferred BS transmit beam, which the base station 110 may select for transmissions to the UE 120. The UE 120 may thus attain and maintain a beam pair link (BPL) with the base station 110 for downlink communications (for example, a combination of the BS transmit beam 305-A and the UE receive beam 310-A), which may be further refined and maintained in accordance with one or more established beam refinement procedures.

A downlink beam, such as a BS transmit beam 305 or a UE receive beam 310, may be associated with a TCI state. A TCI state may indicate a directionality or a characteristic of the downlink beam, such as one or more quasi co-location (QCL) properties of the downlink beam. A QCL property may include, for example, a Doppler shift, a Doppler spread, an average delay, a delay spread, or spatial receive parameters, among other examples. In some examples, each BS transmit beam 305 may be associated with a synchronization signal block (SSB), and the UE 120 may indicate a preferred BS transmit beam 305 by transmitting uplink transmissions in resources of the SSB that are associated with the preferred BS transmit beam 305. A particular SSB may have an associated TCI state (for example, for an antenna port or for beamforming). The base station 110 may, in some examples, indicate a downlink BS transmit beam 305 based at least in part on antenna port QCL properties that may be indicated by the TCI state. A TCI state may be associated with one downlink reference signal set (for example, an SSB and an aperiodic, periodic, or semi-persistent channel state information reference signal (CSI-RS)) for different QCL types (for example, QCL types for different combinations of Doppler shift, Doppler spread, average delay, delay spread, or spatial receive parameters, among other examples). In cases where the QCL type indicates spatial receive parameters, the QCL type may correspond to analog receive beamforming parameters of a UE receive beam 310 at the UE 120. Thus, the UE 120 may select a corresponding UE receive beam 310 from a set of BPLs based at least in part on the base station 110 indicating a BS transmit beam 305 via a TCI indication.

The base station 110 may maintain a set of activated TCI states for downlink shared channel transmissions and a set of activated TCI states for downlink control channel transmissions. The set of activated TCI states for downlink shared channel transmissions may correspond to beams that the base station 110 uses for downlink transmission on a physical downlink shared channel (PDSCH). The set of activated TCI states for downlink control channel communications may correspond to beams that the base station 110 may use for downlink transmission on a physical downlink control channel (PDCCH) or in a control resource set (CORESET). The UE 120 may also maintain a set of activated TCI states for receiving the downlink shared channel transmissions and the CORESET transmissions. If a TCI state is activated for the UE 120, then the UE 120 may have one or more antenna configurations based at least in part on the TCI state, and the UE 120 may not need to reconfigure antennas or antenna weighting configurations. In some examples, the set of activated TCI states (for example, activated PDSCH TCI states and activated CORESET TCI states) for the UE 120 may be configured by a configuration message, such as a radio resource control (RRC) message.

Similarly, for uplink communications, the UE 120 may transmit in the direction of the base station 110 using a directional UE transmit beam, and the base station 110 may receive the transmission using a directional BS receive beam. Each UE transmit beam may have an associated beam ID, beam direction, or beam symbols. among other examples. The UE 120 may transmit uplink communications via one or more UE transmit beams 315.

The base station 110 may receive uplink transmissions via one or more BS receive beams 320. The base station 110 may identify a particular UE transmit beam 315, shown as UE transmit beam 315-A, and a particular BS receive beam 320, shown as BS receive beam 320-A, that provide relatively favorable performance (for example, that have a best channel quality of the different measured combinations of UE transmit beams 315 and BS receive beams 320). In some examples, the base station 110 may transmit an indication of which UE transmit beam 315 is identified by the base station 110 as a preferred UE transmit beam, which the base station 110 may select for transmissions from the UE 120. The UE 120 and the base station 110 may thus attain and maintain a BPL for uplink communications (for example, a combination of the UE transmit beam 315-A and the BS receive beam 320-A), which may be further refined and maintained in accordance with one or more established beam refinement procedures. An uplink beam, such as a UE transmit beam 315 or a BS receive beam 320, may be associated with a spatial relation. A spatial relation may indicate a directionality or a characteristic of the uplink beam, similar to one or more QCL properties, as described above.

In some cases (e.g., as described in Release 15 of the 3GPP standards), for a PDSCH beam, the UE 120 may be configured with up to 128 TCI states. For example, the UE 120 may receive RRC configuration information that indicates up to 128 TCI states. In some cases, up to 8 TCI states can be activated at a time. For example, the UE 120 may receive a medium access control (MAC) control element (CE) (collectively, MAC-CE) that indicates 8 TCI states to be activated. Each of the TCI states may be mapped to a TCI codepoint. For example, each of the TCI states may be mapped to a TCI codepoint using DCI, such as using DCI formats 0_1 or 0_2. In some cases, the DCI may indicate one of the activated TCI states via a TCI field of the DCI. In some cases, the indication by the DCI may only be for the scheduled PDSCH (e.g., may not be applicable to other PDSCHs). In some cases, for CSI-RS, the TCI state may be configured by RRC (e.g., for periodic or aperiodic CSI-RS), or may be indicated by a MAC-CE (e.g., for semi-persistent CSI-RS).

As indicated above, FIG. 3 is provided as an example. Other examples may differ from what is described with respect to FIG. 3.

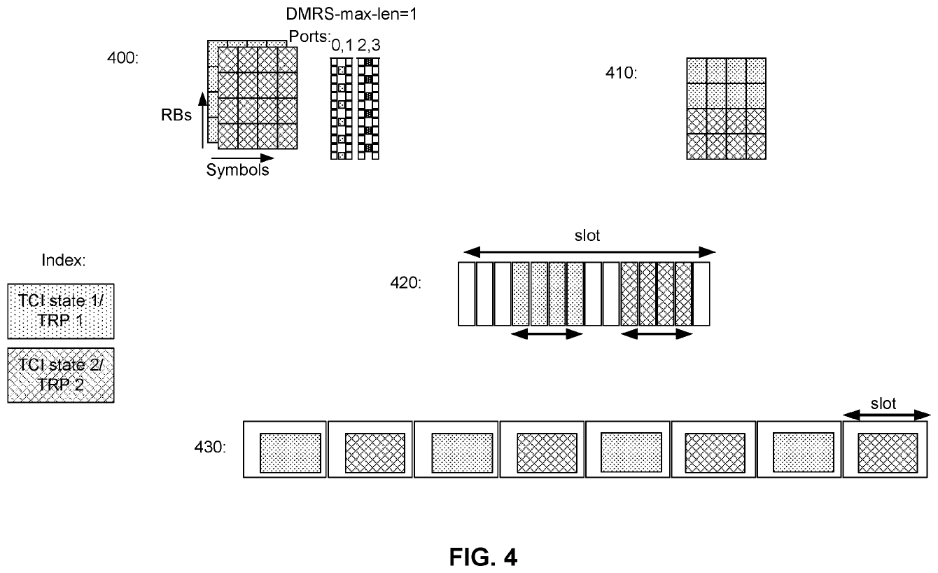

FIG. 4 is a diagram illustrating examples 400, 410, 420, and 430 of communications using a multi-TRP scheme, in accordance with the present disclosure. In some cases (e.g., in Release 16 of the 3GPP standards), the PDSCH may have two TCI states. For example, the PDSCH may have two TCI states for single-DCI based mTRP schemes.

In some cases, as shown in the example 400, the UE 120 may communicate using spatial division multiplexing (SDM). In this case, two TCI states may be used for two sets of layers, or two sets of DMRS ports.

In some cases, as shown in the example 410, the UE 120 may communicate using frequency division multiplexing (FDM). In this case, two TCI states may be used for two sets of resource blocks.

In some cases, as shown in the example 420, the UE 120 may communicate using intra-slot time division multiplexing (TDM). In this case, two DCI states may be used for two repetitions within a slot.

In some cases, as shown in the example 430, the UE 120 may communicate using inter-slot TDM. In this case, two DCI states may be used for multiple (e.g., two or more) repetitions in different slots.

In some cases, the TCI state indications for the schemes shown in examples 400, 410, 420, and/or 430 may be received via DCI that schedules the PDSCH. In some cases, a MAC-CE may activate the TCI states, and may map one or two TCI states to a TCI codepoint. In some cases, the DCI may indicate one TCI codepoint. In some cases, two TCI states may be scheduled if the indicated TCI codepoint is mapped to two TCI states.

In some cases, each TCI codepoint in the DCI (e.g., corresponding to a TCI field value in the DCI) may indicate one TCI state, or two TCI states, for the PDSCH. As described above, a MAC-CE may indicate a mapping if TCI codepoints to the TCI states, and the DCI may indicate one of the TCI codepoints when scheduling the PDSCH. The TCI state(s) corresponding to the indicated TCI codepoints may be used for reception of the PDSCH when the scheduling offset is larger than or equal to a threshold (e.g., timeDurationForQCL). An example of TCI codepoint mapping is shown in Table 1.

TABLE 1
TCI Codepoint Mapping

| TCI Codepoints | TCI States |
|---|---|
| 0 | TCI State ID 3 |
| 1 | TCI State IDs 1 and 4 |
| 2 | TCI State IDs 2 and 6 |
| . . . | . . . |
| 7 | TCI State ID 5 |

In some cases, if at least one TCI codepoint indicates two TCI states, and if the UE 120 is configured with two default TCI states and QCL assumptions (e.g., RRC parameter enableTwoDefaultTCI-States), the default QCL assumptions for the PDSCH (e.g., when the time offset is less than timeDurationForQCL) may be the TCI states corresponding to the lowest codepoint among the TCI codepoints containing two different TCI states (e.g., determined from the MAC-CE activation). In the example of Table 1, this may be TCI states 1 and 4corresponding to codepoint 1.

As indicated above, FIG. 4 is provided as an example. Other examples may differ from what is described with respect to FIG. 4.

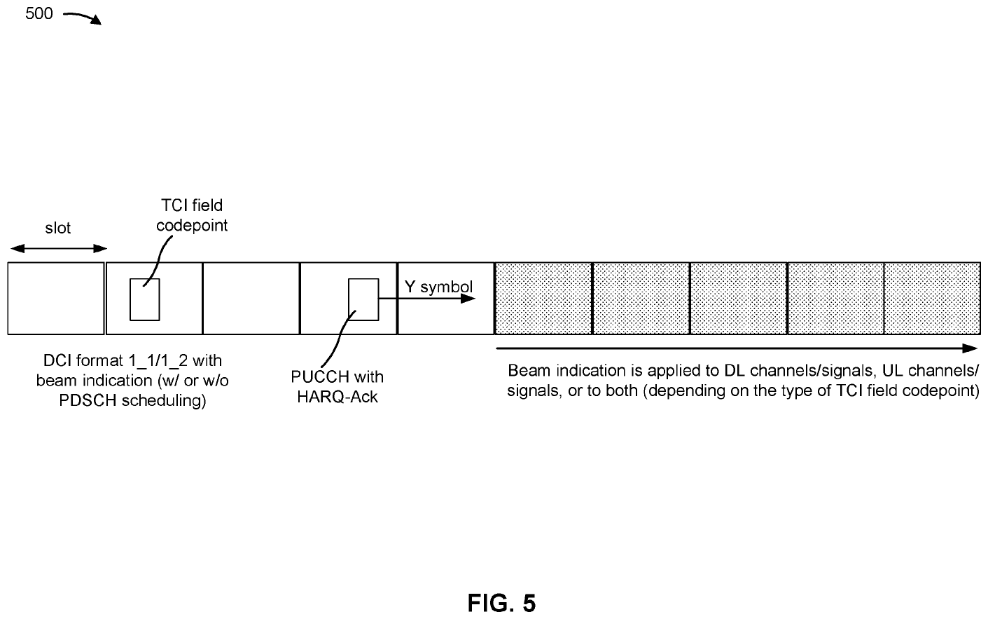

FIG. 5 is a diagram illustrating an example 500 of communications using unified TCI in a single TRP scheme, in accordance with the present disclosure. In some cases (e.g., in Release 17 of the 3GPPP standards), a unified TCI may be RRC configured. In some cases, the unified TCI may include one or more downlink control states, one or more uplink control states, and/or one or more joint uplink and downlink control states that are RRC configured.

In some cases, a MAC-CE may activate one or more RRC configured TCI states, and may map the one or more TCI states to one or more TCI field codepoints, with the following example possibilities:

One TCI field codepoint may represent a joint downlink/uplink TCI state mapped to one TCI codepoint. This may be used for joint downlink/uplink beam indication.

One TCI field codepoint may represent a pair of downlink TCI states and uplink TCI states. This may be used for separate downlink/uplink beam indications.

One TCI field codepoint may represent only a downlink TCI state. This may be used for only downlink beam indication.

One TCI field codepoint may represent only an uplink TCI state. This may be used for only uplink beam indication.

In some cases, if the MAC-CE indicates a mapping to only a single TCI field codepoint, this may serve as the beam indication. For example, 3 ms after the hybrid automatic repeat request acknowledgement (HARQ-ACK) for the PDSCH carrying the MAC-CE is received, the beam indication may be applied.

In some cases, if the MAC-CE indicates a mapping to more than one TCI field codepoint, the downlink DCI (e.g., DCI format 1_1 or 1_2) with or without downlink assignment information can indicate a beam through the TCI field codepoint. For example, the beam indication may be applied in the first slot that is at least Y symbols (e.g., RRC-configured based on the UE 120 capability) after the last symbol of the physical uplink control channel (PUCCH) carrying the HARQ-ACK in response to the DCI.

In some cases, the Release 17 beam indication may differ from the Release 15/16 beam indication in the following example ways:

The beam indication may be sticky. For example, the beam indication is not related to the scheduled PDSCH, and it is not a one-time indication. When the beam indication is applied, the beam indication remains the same for the applicable channels/signals until another DCI (e.g., DCI format 1_1 or 1_2) changes the beam.

The beam indication can be for uplink or for both downlink and uplink, even though it is indicated in DCI formats 1_1 and 1_2.

The beam indication may be common for multiple downlink channels and signals (e.g., PDSCH, PDCCH, CSI-RS) and/or multiple uplink channels and signals (e.g., physical uplink shared channel (PUSCH), PUCCH, sounding reference signal (SRS)).

In the Release 17. the beam indication mechanism is only defined for sTRP schemes (with single TCI state), and is not extended to mTRP.

As indicated above. FIG. 5 is provided as an example. Other examples may differ from what is described with respect to FIG. 5.

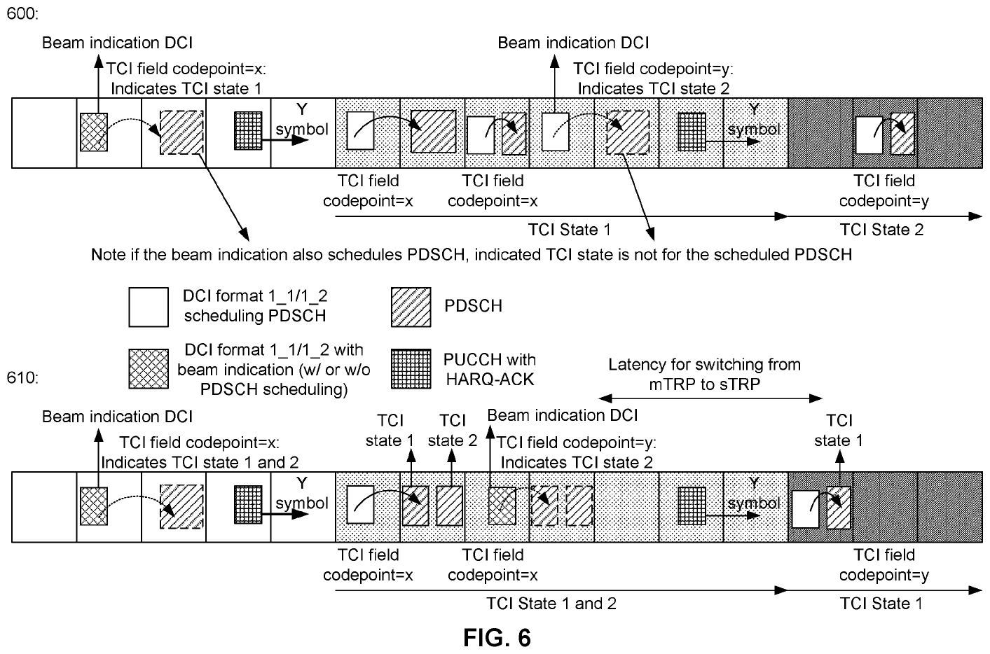

FIG. 6 is a diagram illustrating examples 600 and 610 of beam indication DCI and scheduling DCI, in accordance with the present disclosure.

In some cases, the beam indication DCI and the scheduling DCI may use the same format (e.g., for the PDSCH in the context of Release 17 unified TCI). For example, both the beam indication DCI and the scheduling DCI may use the DCI format 1_1 or the DCI format 1_2. However, there may be one or more differences between the beam indication DCI and the scheduling DCI. For example, the beam indication DCI may or may not, schedule the PDSCH. In contrast, the scheduling DCI may always schedule the PDSCH. If the scheduling DCI changes the TCI states (e.g., indicates a different TCI codepoint than the previous DCI), the scheduling DCI may become a beam indication DCI. In this case, as shown in the example 600, the scheduled PDSCH may follow the previously indicated TCI state (and not the TCI state indicated in the scheduling DCI), as the TCI state is applied in the first slot after Y symbols (after the HARQ-ACK).

In Release 18 of the 3GPP standards, the unified TCI may be extended to mTRP schemes for indicating two TCI states (e.g., two downlink TCI states, or two joint downlink and uplink TCI states) for the PDSCH (as well as other channels and/or signals).

In some cases, when two TCI states are applied to PDSCH transmissions starting from a given time (e.g., the first slot that is at least Y symbols after the last symbol of the HARQ-ACK), the base station 110 may still need to schedule the sTRP operation with one TCI state among the two applied TCI states. For example, the fallback DCIs may not be able to schedule mTRP schemes (e.g., DCI format 1_0 for PDSCH scheduling and DCI format 0_0 for PUSCH scheduling), In addition, the mTRP scheduling may not be needed all the time (e.g. when eMBB traffic is being scheduled, or when resources at both TRPs are not available).

In some cases, the beam indication DCI may be used to switch to the sTRP (e.g., from {TCI state 1, TCI state 2} to TCI state 1 only). However, as shown in the example 610, this may result in latency since the TCI state(s) indicated by the beam indication DCI (e.g., by the TCI codepoint) are not for the scheduled PDSCH (and may only be applied starting from the first slot after Y symbols after HARQ-ACK). This may be true even if the indicated TCI state is a previously indicated TCI state (e.g., is not a new TCI state).

In some cases, two bits may be added to the DCI format 1_1 or 1_2 in order to enable the scheduling DCI to indicate if the scheduled PDSCH has TCI state 1 only, TCI state 2 only, or both TCI state 1 and TCI state 2 (and possibly the order between them) without changing the TCI codepoint after the beam indication DCI indicates that TCI states 1 and 2 are applied. However, this may result in increased overhead (e.g., due to the extra bits required for the signaling).

Techniques and apparatuses are described herein for a TCI indicator for DCI. In some aspects, the UE 120 may receive first DCI having a first TCI field that indicates a pair of TCI states to be used after a first time. The first DCI may be beam indication DCI that does not schedule a PDSCH. The UE 120 may receive second DCI having a second TCI field that indicates a selected one or more TCI states, of the pair of TCI states, to be used for a PDSCH. The second DCI may be scheduling DCI that schedules the PDSCH. The second TCI field may indicate for the UE 120 to use a first TCI state, a second TCI state, or both the first TCI state and the second TCI state, of the pair of TCI states, for communicating the information.

As described above, using beam indication DCI to indicate a switch from one TCI state to another TCI state may result in increased latency (e.g., since the TCI states indicated by the beam indication DCI are not for the scheduled PDSCH). Additionally, adding one or more bits to the scheduling DCI to indicate the switch from one TCI state to another TCI state may result in increased overhead. Using the techniques and apparatuses described herein, the base station 110 and the UE 120 may be configured to switch between the TCI states using the traditional scheduling DCI (e.g., without the one or more extra bits). Thus, TCI state switching may occur without the increased latency and overhead.

As indicated above, FIG. 6 is provided as an example. Other examples may differ from what is described with respect to FIG. 6.

FIG. 7 is a diagram illustrating an example 700 of a TCI indicator for DCI, in accordance with the present disclosure. A network node, such as the network node 705, may communicate with a UE, such as the UE 120.

As shown in connection with reference number 710, the network node 705 may transmit, and the UE 120 may receive, first DCI having a first TCI field that indicates a pair of TCI states to be used after a first time. In some aspects, the first DCI may be beam indication DCI. For example, the first DCI may be beam indication DCI that does not schedule a PDSCH, or may be beam indication DCI that schedules a PDSCH. In some aspects, the first DCI may have a DCI format 1_1 or a DCI format 1_2. In some aspects, the pair of TCI states may be two downlink TCI states, or two joint uplink and downlink states.

As shown in connection with reference number 715, the network node 705 may transmit, and the UE 120 may receive, second DCI having a second TCI field that indicates a selected one or more TCI states, of the pair of TCI states, to be used for a PDSCH. In some aspects, the second DCI may be scheduling DCI. For example, the second DCI may be scheduling DCI that schedules a PDSCH. In some aspects, the second DCI may have a DCI format 1_1 or a DCI format 1_2. For example, the second DCI may have the same format as the first DCI.

In some aspects, after the first DCI indicates the pair of TCI states to be applied from the first time, the TCI field of a subsequent DCI (e.g., the second TCI field of the second DCI) that schedules PDSCH may be interpreted differently. The interpretation may depend on the pair of TCI states indicated in the previous DCI (e.g., the first DCI). In some aspects, the interpretation of the second TCI field may be for the scheduled PDSCH. In some aspects, the second TCI field of the second DCI may indicate whether to use both TCI states indicated by the first DCI, or only use one of the two TCI states for the scheduled PDSCH. For example, the second TCI field may indicate to use a first TCI state (e.g., TCI state 1), a second TCI state (e.g., TCI state 4), or both the first TCI state and the second TCI state (e.g., TCI states 1 and 4), of the pair of TCI states. In some aspects, the second TCI field may indicate an order to be applied to the two TCI states for the scheduled PDSCH (e.g., to different sets of layers for SDM, different sets of resource blocks for FDM, or different sets of repetitions for TDM). For example, the second TCI field may indicate to use the first TCI state (TCI state 1) prior to the second TCI state (TCI state 4), or to use the second TCI state (TCI state 4) prior to the first TCI state (TCI state 1).

In a first example option, the two most significant bits (MSB), or the two least significant bits (LSB), of the TCI field in the DCI format 1_1 or DCI format 1_2 (e.g., the second TCI field in the second DCI) may be used to indicate the four possibilities (e.g., TCI state 1, TCI state 4, TCI state 1 and 4, or TCI state 4 and 1).

In a second example option, the first four codepoints, or the last four codepoints, of the TCI field in the DCI format 1_1 or DCI format 1_2 (e.g., the second TCI field in the second DCI) may be used to indicate the four possibilities (e.g., TCI state 1, TCI state 4, TCI state 1 and 4, or TCI state 4 and 1).

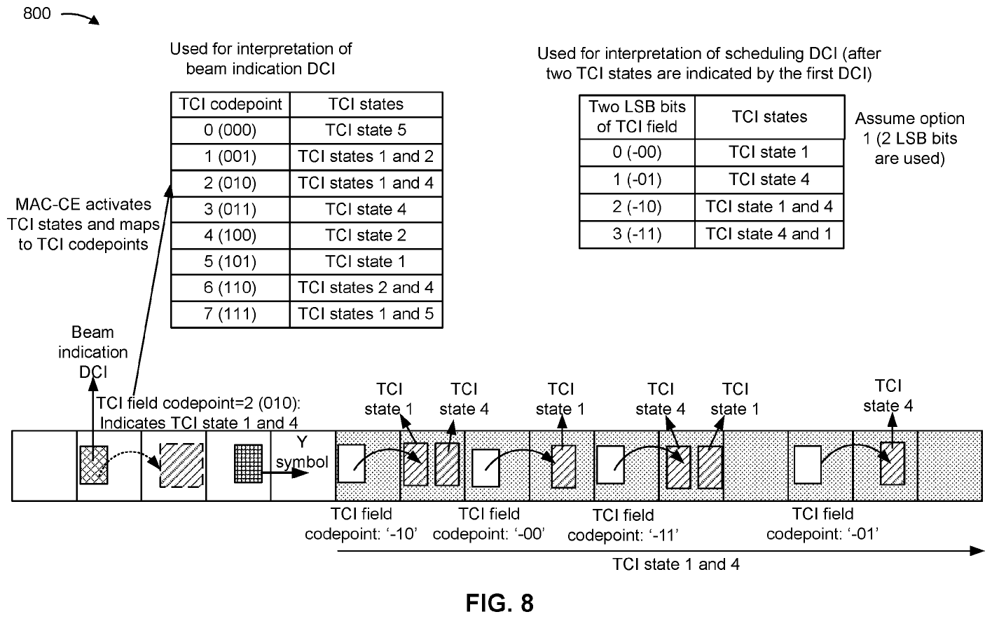

In some aspects, a first table may indicate a mapping between the first TCI field and a plurality of TCI states. In some aspects, a second table may indicate a mapping between one or more bits (e.g., the two MSB or the two LSB) or one or more codepoints (e.g., the first four codepoints or the last four codepoints), indicated in the second TCI field, and the one or more TCI states of the plurality of TCI states (e.g., the four possibilities described above). Additional details regarding these features are described below in connection with FIG. 8.

As shown in connection with reference number 720, the network node 705 and the UE 120 may communicate based at least in part on the first DCI and the second DCI. For example, the UE 120 and the network node 705 may communicate based at least in part on the pair of TCI states indicated in the first TCI field of the first DCI and/or the selected one or more of the pair of TCI states indicated in the second TCI field of the second DCI, among other examples.

In some aspects, the UE 120 and the network node 705 may communicate capability information. For example, the UE 120 may transmit capability information that indicates whether or not the UE 120 can support the TCI state information signaling indicated in the first TCI field of the first DCI and/or the second TCI field of the second TCI, among other examples. In some aspects, during the time that two TCI states are indicated to be applied by the first DCI, the ability of the UE 120 to be scheduled with one of the two TCI states for PDSCH (or to be scheduled with the two orders between the two TCI states) can be indicated by the capability signaling if the UE 120.

As shown in connection with reference number 725, the network node 705 may transmit, and the UE 120 may receive, third DCI having a third TCI field that indicates to use one or more other TCI states after a second time. In some aspects, the third DCI may be beam indication DCI. For example, the third DCI may be beam indication DCI that does not schedule a PDSCH, or may be beam indication DCI that schedules a PDSCH. In some aspects, the third DCI may have a DCI format 1_1 or a DCI format 1_2. For example, the third DCI may have the same DCI format as the first DCI and/or the second DCI.

In some aspects, after the first DCI format 1_1 or 1_2 (with or without scheduling PDSCH) indicates the two TCI states (e.g., downlink, or joint downlink and uplink) to be applied from the first time, another DCI format 1_1 or 1_2 may indicate one or two new TCI states (e.g., downlink, or joint downlink and uplink) to be used (e.g., applied) from a second time. For example, after receiving the first DCI having the first TCI field that indicates the first pair of TCI states (and, optionally, after receiving the second DCI having the second TCI field), the UE 120 may receive third DCI having a third TCI field that indicates to use one or more other TCI states after the second time.

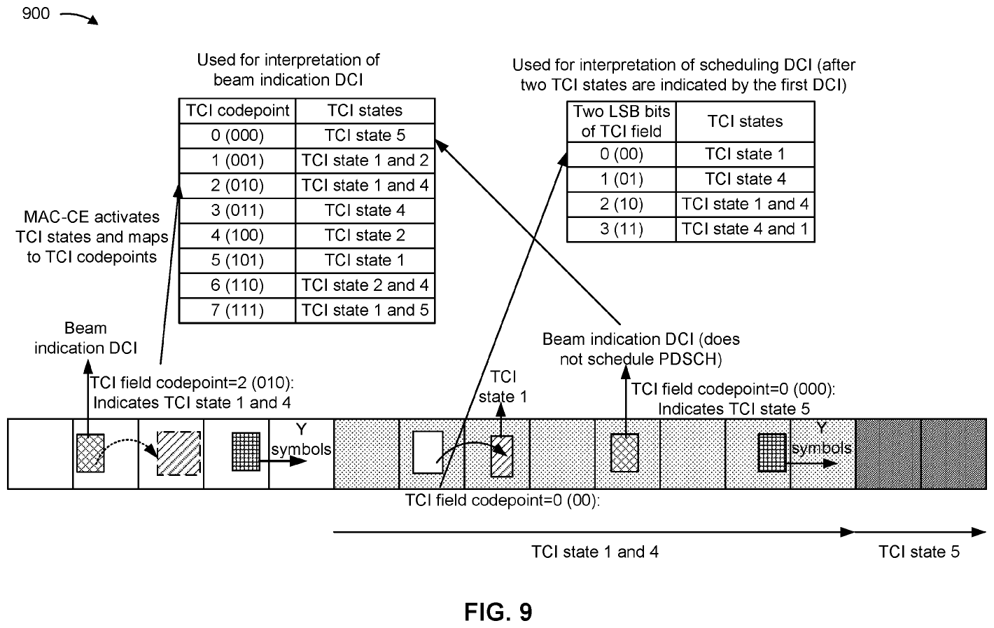

In a first example, the third DCI may be DCI (e.g., beam indication DCI) that does not schedule a PDSCH. In this example, the UE 120 may determine that the third TCI field, of the third DCI, should be interpreted based at least in part on the original table, as indicated by the MAC-CE (e.g., since the third DCI does not schedule the PDSCH). For example, the UE 120 may map the third TCI field to the plurality of TCI states in the same way that the UE 120 mapped the first TCI field to the plurality of TCI states (e.g., using the first table described above). Additional details regarding these features are described in connection with FIG. 9.

In the first example, the DCI format 1_1 or 1_2 that schedules the PDSCH (e.g., the third DCI) may not be able to be used for beam indication DCI when the two TCI states are previously indicated to be applied. Thus, the third TCI field may be interpreted similarly, or the same as, the first TCI field. In some aspects, this condition may not always be true if, previously, only one TCI state is indicated to be applied (e.g., in the first TCI field of the first DCI). In that case, the beam indication with the scheduling PDSCH may be used as in the Release 17.

In a second example, the third DCI may be DCI that may, or may not, schedule the PDSCH. If the third DCI does not schedule the PDSCH, the TCI codepoints (e.g., as indicated by the MAC-CE) may be available for the TCI state and beam indication, as described above in connection with the first example. If the third DCI does schedule the PDSCH, the TCI field (e.g., the third TCI field) may be used to indicate the one or more TCI states for the PDSCH (e.g., similar to the first example) and to indicate whether or not to switch to the one or more other TCI states for the second beam indication. For example, a first portion of the third TCI field may be used to indicate the TCI states for the PDSCH, and a second portion of the third TCI field may indicate to switch to the one or more other TCI states, or not to switch to the one or more other TCI states. In this example, the second portion of the third TCI field may indicate whether or not to switch to the one or more other TCI states, but may not indicate the actual TCI states to be used for the one or more other TCI states.

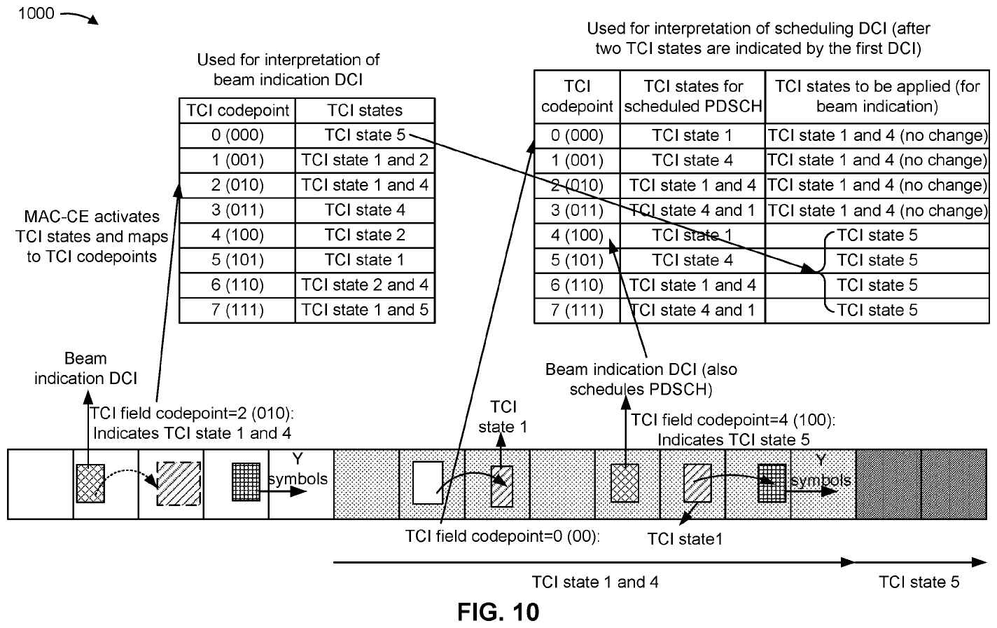

In some aspects. the second portion of the third TCI field may include a single bit that indicates whether or not the UE 120 should switch from the first pair of TCI states to the one or more other TCI states. For example, a first state of the bit (e.g., state 0) may indicate that the UE 120 should not switch (e.g., continue to use the first pair of TCI states) and a second state of the bit (e.g., state 1) may indicate that the UE 120 should switch TCI states (e.g., to the one or more other TCI states). In the example that the bit indicates to switch to the one or more other TCI states, the one or more other TCI states (e.g., one or two states) may be determined based at least in part on one or more rules (e.g., a default rule). For example. among the plurality of TCI codepoints mapped to the TCI states by the MAC-CE (e.g., in the first table), the lowest codepoint that does not map to the same pair of TCI states indicated by the first DCI may be used to determine the one or more other TCI states. Additionally, or alternatively. the one or more other TCI states may be determined based at least in part on information received from the network node 705. For example, the network node 705 may transmit an RRC message, a MAC-CE, or DCI that indicates the one or more other TCI states. Additional details regarding these features are described below in connection with FIG. 10.

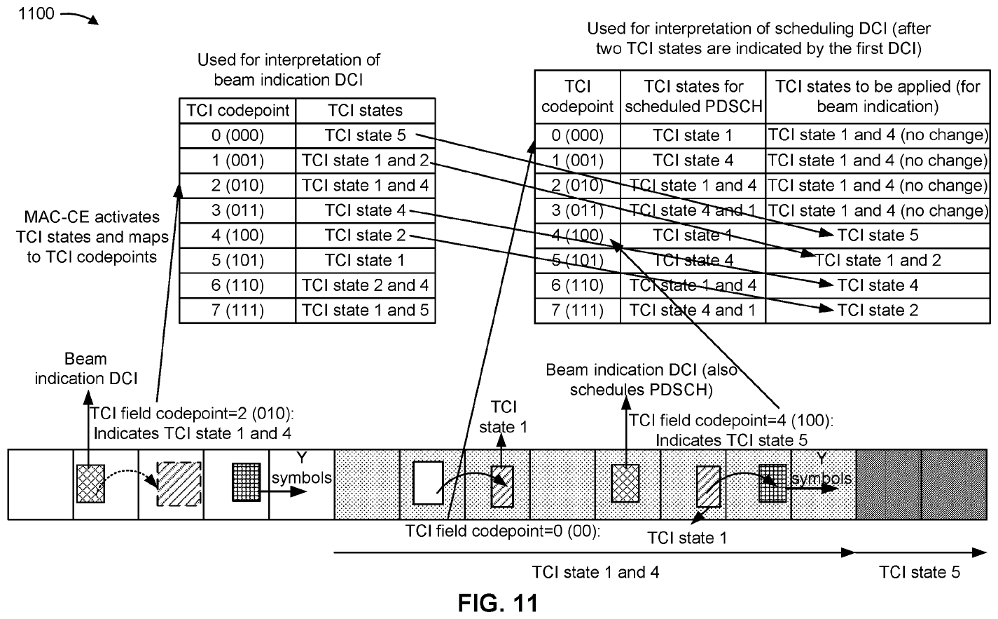

In some aspects, the second portion of the third TCI field may indicate a plurality of codepoints. A first portion of the codepoints (e.g., the first four codepoints) may indicate no change to the TCI states to be applied (e.g., continue to use the first pair of TCI states). A second portion of the codepoints can be used to indicate a number of possibilities for the one or more other TCI states. In one example. there may be X total number of codepoints that can be indicated in the second portion of the third TCI. Since the first four codepoints are used to indicate the possibilities for the first pair of TCI states, a remainder of the codepoints (e.g., X−4) may be used to indicate the possibilities for the one or more other TCI states. In some aspects, the possibilities for the one or more other TCI states may be determined based at least in part on one or more rules (e.g., a default rule). For example, among the TCI codepoints mapped to the TCI states by the MAC-CE (e.g., in the first table), the X−4 lowest codepoints that do not map to the same two states indicated by the first DCI are assumed to determine the X−4 possibilities for the one or more other TCI states. In another example, the X−4 possibilities for the one or more other TCI states may be determined based at least in part on information received from the network node 705. For example. the network node 705 may transmit an RRC message. a MAC-CE, or DCI that indicates the one or more other TCI states. Additional details regarding these features are described below in connection with FIG. 11.

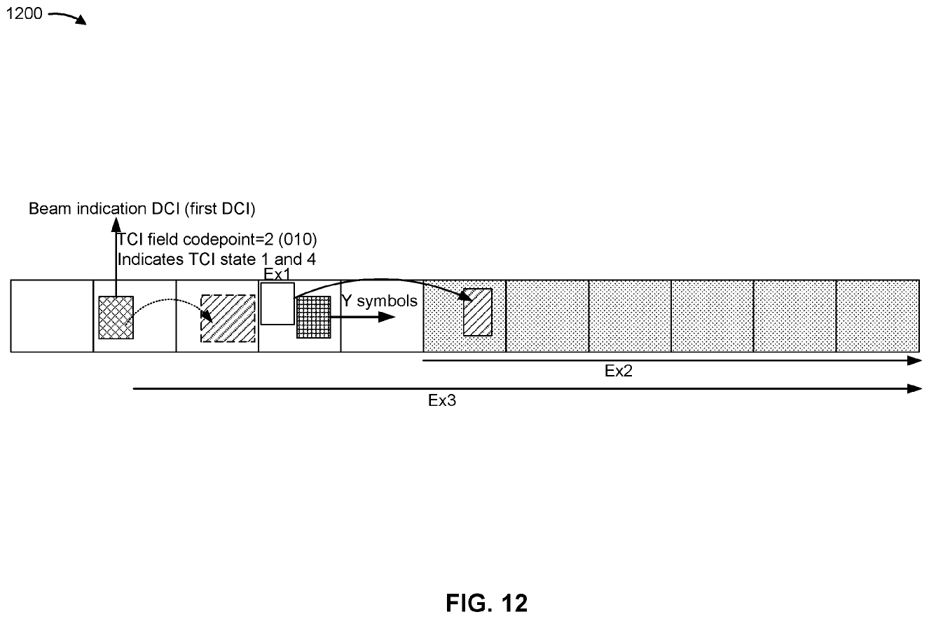

As described herein, the third DCI having the third TCI field may be a subsequent DCI that schedules a PDSCH. In some aspects, the third DCI may be a subsequent DCI that schedules the PDSCH only if the third DCI has format 1_1 or 1_2, that schedules the PDSCH, and if the scheduled PDSCH is received after the beam indication from the first DCI is applied (e.g., the first slot that is at least Y symbols after the HARQ-ACK scheduled by the first DCI). In some aspects, the third DCI may be a subsequent DCI that schedules the PDSCH only if the third DCI has format 1_1 or 1_2, that schedules the PDSCH, and if the third DCI is received after the beam indication from the first DCI is applied (e.g., the first slot that is at least Y symbols after the HARQ-ACK scheduled by the first DCI). In some aspects, the third DCI may be a subsequent DCI that schedules the PDSCH only if the third DCI has format 1_1 or 1_2, that schedules the PDSCH, and if the third DCI is received in a PDCCH monitoring occasion that is after the PDCCH monitoring occasion for the first DCI (e.g., either immediately after, or on the same PDCCH monitoring occasion or later). Additional details regarding these features are described below in connection with FIG. 12.

As described above, using beam indication DCI to indicate a switch from one TCI state to another TCI state may result in increased latency (e.g., since the TCI states indicated by the beam indication DCI are not for the scheduled PDSCH). Additionally, adding one or more bits to the scheduling DCI to indicate the switch from one TCI state to another TCI state may result in increased overhead. Using the techniques and apparatuses described herein, the network node 705 and the UE 120 may be configured to switch between the TCI states using the traditional scheduling DCI (e.g., without the one or more extra bits). Thus, TCI state switching may occur without the increased latency and overhead.

As indicated above, FIG. 7 is provided as an example. Other examples may differ from what is described with respect to FIG. 7.

FIG. 8 is a diagram illustrating a first example 800 of TCI state selection, in accordance with the present disclosure. As shown, the UE 120 may receive first DCI (e.g., in symbol 2) that indicates a TCI field codepoint 2 (010). The UE 120 may be configured to determine one or more TCI states corresponding to the TCI codepoint based at least in part on a table (e.g., the first table described above). For example, the first table may indicate that the TCI field codepoint 2 corresponds to the pair of TCI states 1 and 4. Thus, the UE 120 may be configured to communicate using the TCI states 1 and 4 after the number of symbols Y (e.g., as indicated in an RRC configuration).

In some aspects, the UE 120 may receive second DCI that indicates one or more TCI states, of the pair of TCI states, to be used to be used for a PDSCH. The second DCI may have the same format as the first DCI (e.g., format 1_1 or 1_2). The first DCI may be beam indication DCI, whereas the second DCI may be scheduling DCI (e.g., may schedule the PDSCH). As described above, the UE 120 may interpret the TCI field of the second DCI differently than the TCI field of the first DCI, based at least in part on the second DCI being scheduling DCI.

As shown in the example 800, the UE 120 may receive second DCI (e.g., in symbol 6) having a second TCI field that indicates (e.g., in the two LSBs of the second TCI field) the TCI codepoint 2 (10). The UE 120 may be configured to determine one or more TCI states, and an order of the TCI states, corresponding to the TCI codepoint based at least in part on a table (e.g., the second table described above). For example, the second table may indicate that the TCI field codepoint 2 (10) indicated by the second DCI corresponds to the pair of TCI states 1 and 4. Thus, the UE 120 may communicate (e.g., in symbol 7) using the TCI states 1 and 4 (in that order).

Additionally, or alternatively, the UE 120 may receive second DCI (e.g., in symbol 8) having a second TCI field that indicates the TCI codepoint 0 (00). The UE 120 may determine, based at least in part on the information in the second table, that the TCI field codepoint 0 (00) corresponds to the TCI state 1. Thus, the UE 120 may communicate (e.g., in symbol 9) using the TCI state 1.

Additionally, or alternatively, the UE 120 may receive second DCI (e.g., in symbol 10) having a second TCI field that indicates the TCI codepoint 3 (11). The UE 120 may determine, based at least in part on the information in the second table, that the TCI field codepoint 3 (11) corresponds to the TCI states 4 and 1. Thus, the UE 120 may communicate (e.g., in symbol 11) using the TCI states 4 and 1 (in that order).

Additionally, or alternatively, the UE 120 may receive second DCI (e.g., in symbol 13) having a second TCI field that indicates the TCI codepoint 1 (01). The UE 120 may determine, based at least in part on the information in the second table, that the TCI field codepoint 1 (01) corresponds to the TCI state 4. Thus, the UE 120 may communicate (e.g., in symbol 14) using the TCI state 4.

As indicated above, FIG. 8 is provided as an example. Other examples may differ from what is described with respect to FIG. 8.

FIG. 9 is a diagram illustrating a second example 900 of TCI state selection, in accordance with the present disclosure.

As described above, the UE 120 may receive third DCI having a third TCI field that indicates to use one or more other TCI states after a second time. The third DCI may not schedule a PDSCH. In this case, the UE 120 may determine that the third TCI field, of the third DCI, should be interpreted based at least in part on the original table, as indicated by the MAC-CE (e.g., since the third DCI does not schedule the PDSCH). For example, the UE 120 may map the third TCI field to the plurality of TCI states in the same way that the UE 120 mapped the first TCI field to the plurality of TCI states (e.g., using the first table described above).

As shown in the example 900, the UE 120 may receive third DCI (e.g., in symbol 10) having a third TCI field that indicates the TCI codepoint 0 (000). Since the third DCI does not schedule the PDSCH, the UE 120 may determine the corresponding TCI states based at least in part on the information in the first table. Thus, the UE 120 may communicate using the TCI state 5 after the number of symbols Y.

As indicated above, FIG. 9 is provided as an example. Other examples may differ from what is described with respect to FIG. 9.

FIG. 10 is a diagram illustrating a third example 1000 of TCI state selection, in accordance with the present disclosure.

In some aspects, the UE 120 may receive third DCI (e.g., in symbol 10) having a third TCI field that indicates to use one or more other TCI states after a second time. The third DCI may schedule the PDSCH. In this case, the third TCI field may be used to indicate the one or more TCI states for the PDSCH (e.g., similar to the first example) and to indicate whether or not to switch to the one or more other TCI states for the second beam indication. For example, a first portion of the third TCI field may be used to indicate the TCI states for the PDSCH, and a second portion of the third TCI field may indicate to switch to the one or more other TCI states, or not to switch to the one or more other TCI states.

In some aspects, the second portion of the third TCI field may include a single bit that indicates whether or not the UE 120 should switch from the first pair of TCI states to the one or more other TCI states. For example, a first state of the bit (e.g., state 0) may indicate that the UE 120 should not switch (e.g., continue to use the first pair of TCI states) and a second state of the bit (e.g., state 1) may indicate that the UE 120 should switch TCI states (e.g., to the one or more other TCI states). As shown in the example 1000, if the first bit of the third TCI field is 0, the UE 120 may use the first pair of TCI states (as indicated in the first DCI). Alternatively, if the first bit of the third TCI field is 1, the UE 120 may use the one or more other TCI states. As described above, while the third TCI field may indicate to switch to the one or more other TCI states, the third TCI field may not indicate the actual TCI states of the one or more other TCI states.

In the example that the bit indicates to switch to the one or more other TCI states, the one or more other TCI states may be determined based at least in part on one or more rules (e.g., a default rule). For example, among the plurality of TCI codepoints mapped to the TCI states by the MAC-CE (e.g., in the first table), the lowest codepoint that does not map to the same pair of TCI states indicated by the first DCI may be used to determine the one or more other TCI states. As shown in the example 1000, the lowest TCI codepoint from the first table, that does not map to the pair of TCI states 1 and 4, is TCI codepoint 0, which maps to TCI state 5. Thus, the UE 120 may be configured to communicate using TCI state 5 after the number of symbols Y.

As indicated above, FIG. 10 is provided as an example. Other examples may differ from what is described with respect to FIG. 10.

FIG. 11 is a diagram illustrating a fourth example 1100 of TCI state selection, in accordance with the present disclosure.

In some aspects, the second portion of the third TCI field may indicate a plurality of codepoints. A first portion of the codepoints (e.g., the first four codepoints) may indicate no change to the TCI states to be applied (e.g., continue to use the first pair of TCI states). A second portion of the codepoints can be used to indicate a number of possibilities for the one or more other TCI states. In one example, there may be X total number of codepoints that can be indicated in the second portion of the third TCI. Since the first four codepoints are used to indicate the possibilities for the first pair of TCI states, a remainder of the codepoints (e.g., X−4) may be used to indicate the possibilities for the one or more other TCI states.

As shown in the example 1100, the first four codepoints may be used to indicate TCI state 1, TCI state 2, TCI states 1 and 4, and TCI states 4 and 1, as indicated in the first TCI field of the first DCI. In contrast, the second four codepoints may correspond to the lowest four codepoints that do not correspond to the TCI states indicated in the first TCI field of the first DCI. The second four codepoints may correspond to TCI codepoint 0 (000), TCI codepoint 1(001), TCI codepoint 3 (011), and TCI codepoint 4 (100). In this example, the third DCI may indicate to communicate using TCI codepoint 100, which corresponds to TCI state 5. Thus, the UE 120 may communicate using TCI state 5 after the number of Y symbols.

As indicated above. FIG. 11 is provided as an example. Other examples may differ from what is described with respect to FIG. 11.

FIG. 12 is a diagram illustrating an example 1200 of subsequent DCI that schedules the PDSCH, in accordance with the present disclosure.

As described above, the third DCI having the third TCI field may be a subsequent DCI that schedules a PDSCH. In some aspects, the third DCI may be a subsequent DCI that schedules the PDSCH only if the third DCI has format 1_1 or 1_2, that schedules the PDSCH, and if the scheduled PDSCH is received after the beam indication from the first DCI is applied (e.g., the first slot that is at least Y symbols after the HARQ-ACK scheduled by the first DCI). In some aspects, the third DCI may be a subsequent DCI that schedules the PDSCH only if the third DCI has format 1_1 or 1_2, that schedules the PDSCH, and if the third DCI is received after the beam indication from the first DCI is applied (e.g., the first slot that is at least Y symbols after the HARQ-ACK scheduled by the first DCI). In some aspects, the third DCI may be a subsequent DCI that schedules the PDSCH only if the third DCI has format 1_1 or 1_2, that schedules the PDSCH, and if the third DCI is received in a PDCCH monitoring occasion that is after the PDCCH monitoring occasion for the first DCI (e.g., either immediately after, or on the same PDCCH monitoring occasion or later).

As indicated above, FIG. 12 is provided as an example. Other examples may differ from what is described with respect to FIG. 12.

FIG. 13 is a diagram illustrating an example process 1300 performed, for example, by a UE, in accordance with the present disclosure. Example process 1300 is an example where the UE (e.g., UE 120) performs operations associated with TCI for DCI.

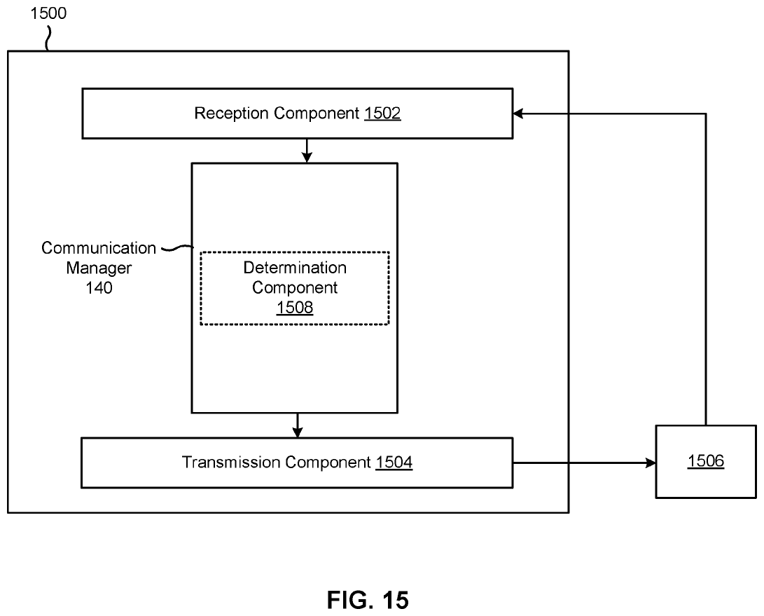

As shown in FIG. 13, in some aspects, process 1300 may include receiving first DCI having a first TCI field that indicates a pair of TCI states to be used after a first time (block 1310). For example, the UE (e.g., using communication manager 140 and/or reception component 1502, depicted in FIG. 15) may receive first DCI having a first TCI field that indicates a pair of TCI states to be used after a first time, as described above.

As further shown in FIG. 13, in some aspects, process 1300 may include receiving second DCI having a second TCI field that indicates a selected one or more TCI states, of the pair of TCI states, to be used for a PDSCH (block 1320). For example, the UE (e.g., using communication manager 140 and/or reception component 1502, depicted in FIG. 15) may receive second DCI having a second TCI field that indicates a selected one or more TCI states, of the pair of TCI states, to be used for a PDSCH, as described above.

Process 1300 may include additional aspects, such as any single aspect or any combination of aspects described below and/or in connection with one or more other processes described elsewhere herein.

In a first aspect, the first DCI is beam indication DCI that does not schedule a PDSCH, and the second DCI is scheduling DCI that schedules a PDSCH.

In a second aspect, alone or in combination with the first aspect, the second TCI field indicates to use a first TCI state, a second TCI state, or both the first TCI state and the second TCI state, of the pair of TCI states, for communicating the information.

In a third aspect, alone or in combination with one or more of the first and second aspects, the second TCI field indicates an order of the TCI states, of the pair of TCI states, for communicating the information.

In a fourth aspect, alone or in combination with one or more of the first through third aspects, the one or more TCI states, and an order of the one or more TCI states, are indicated in a two most significant bits, or a two least significant bits, of the second TCI field.

In a fifth aspect, alone or in combination with one or more of the first through fourth aspects, the one or more TCI states, and an order of the one or more TCI states, are indicated in a first four codepoints, or a last four codepoints, of the second TCI field.

In a sixth aspect, alone or in combination with one or more of the first through fifth aspects, process 1300 includes receiving a third DCI having a third TCI field that indicates to use one or more other TCI states after a second time.

In a seventh aspect, alone or in combination with one or more of the first through sixth aspects, the third DCI is beam indication DCI that does not schedule a physical downlink shared channel.

In an eighth aspect, alone or in combination with one or more of the first through seventh aspects, the one or more other TCI states are determined based at least in part on a mapping, associated with the first DCI, between a plurality of bits of the third TCI field and a plurality of possible TCI states.

In a ninth aspect, alone or in combination with one or more of the first through eighth aspects, the third DCI is beam indication DCI that schedules a PDSCH.

In a tenth aspect, alone or in combination with one or more of the first through ninth aspects, a first portion of the third TCI field indicates one or more TCI states for the PDSCH, and a second portion of the third TCI field includes information associated with the one or more other TCI states.

In an eleventh aspect, alone or in combination with one or more of the first through tenth aspects, the information associated with the one or more other TCI states includes a bit that indicates whether the pair of TCI states, or the one or more other TCI states, should be used after the second time.

In a twelfth aspect, alone or in combination with one or more of the first through eleventh aspects, process 1300 includes determining the one or more other TCI states based at least in part on a lowest codepoint that does not correspond to the pair of TCI states.

In a thirteenth aspect, alone or in combination with one or more of the first through twelfth aspects, process 1300 includes determining the one or more other TCI states based at least in part on receiving a radio resource control message, a medium access control message, or other DCI that indicates the one or more other TCI states.

In a fourteenth aspect, alone or in combination with one or more of the first through thirteenth aspects, the information associated with the one or more other TCI states indicates a first plurality of codepoints indicating the pair of TCI states, and a second plurality of codepoints indicating the one or more other TCI states.

In a fifteenth aspect, alone or in combination with one or more of the first through fourteenth aspects, process 1300 includes determining the one or more other TCI states based at least in part on a lowest four codepoints that do not correspond to the pair of TCI states.

In a sixteenth aspect, alone or in combination with one or more of the first through fifteenth aspects, process 1300 includes determining the one or more other TCI states based at least in part on one or more codepoints that are indicated in a radio resource control message, a medium access control message, or other DCI.

In a seventeenth aspect, alone or in combination with one or more of the first through sixteenth aspects, process 1300 includes determining that the third DCI is scheduling DCI, if the third DCI has DCI format 1_1 or DCI format 1_2, the third DCI schedules a physical downlink shared channel (PDSCH), and the scheduled PDSCH is received after a beam indication from the first DCI is applied, the third DCI is received after the beam indication from the first DCI is applied, or the third DCI is received in a physical downlink control channel (PDCCH) monitoring occasion that is after a PDCCH monitoring occasion for the first DCI.

In an eighteenth aspect, alone or in combination with one or more of the first through seventeenth aspects, process 1300 includes transmitting capability information associated with receiving the first DCI, having the first TCI field, and the second DCI, having the second TCI field.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, by a network node, in accordance with the present disclosure. Example process 1400 is an example where the network node (e.g., network node 705) performs operations associated with TCI for DCI.

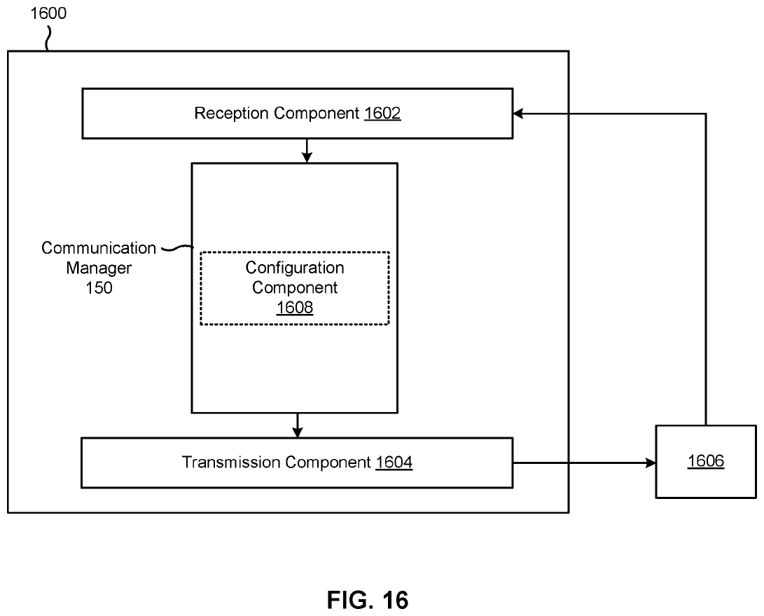

As shown in FIG. 14, in some aspects, process 1400 may include transmitting first DCI having a first TCI field that indicates a pair of TCI states to be used after a first time (block 1410). For example, the network node (e.g., using communication manager 150 and/or transmission component 1604, depicted in FIG. 16) may transmit first DCI having a first TCI field that indicates a pair of TCI states to be used after a first time, as described above.

As further shown in FIG. 14, in some aspects, process 1400 may include transmitting second DCI having a second TCI field that indicates a selected one or more TCI states, of the pair of TCI states, to be used for a PDSCH (block 1420). For example, the network node (e.g., using communication manager 150 and/or transmission component 1604, depicted in FIG. 16) may transmit second DCI having a second TCI field that indicates a selected one or more TCI states, of the pair of TCI states, to be used for a PDSCH, as described above.

Process 1400 may include additional aspects, such as any single aspect or any combination of aspects described below and/or in connection with one or more other processes described elsewhere herein.

In a first aspect, the first DCI is beam indication DCI that does not schedule a physical downlink shared channel (PDSCH), and the second DCI is scheduling DCI that schedules a PDSCH.

In a second aspect, alone or in combination with the first aspect, the second TCI field indicates to use a first TCI state, a second TCI state, or both the first TCI state and the second TCI state, of the pair of TCI states, for communicating the information.

In a third aspect, alone or in combination with one or more of the first and second aspects, the second TCI field indicates an order of the TCI states, of the pair of TCI states, for communicating the information.

In a fourth aspect, alone or in combination with one or more of the first through third aspects, the one or more TCI states, and an order of the one or more TCI states, are indicated in a two most significant bits, or a two least significant bits, of the second TCI field.

In a fifth aspect, alone or in combination with one or more of the first through fourth aspects, the one or more TCI states, and an order of the one or more TCI states, are indicated in a first four codepoints, or a last four codepoints, of the second TCI field.

In a sixth aspect, alone or in combination with one or more of the first through fifth aspects, process 1400 includes transmitting third DCI having a third TCI field that indicates to use one or more other TCI states after a second time.

In a seventh aspect, alone or in combination with one or more of the first through sixth aspects, the third DCI is beam indication DCI that does not schedule a physical downlink shared channel.

In an eighth aspect, alone or in combination with one or more of the first through seventh aspects, the one or more other TCI states are determined based at least in part on a mapping, associated with the first DCI, between a plurality of bits of the third TCI field and a plurality of possible TCI states.

In a ninth aspect, alone or in combination with one or more of the first through eighth aspects, the third DCI is beam indication DCI that schedules a physical downlink shared channel (PDSCH).

In a tenth aspect, alone or in combination with one or more of the first through ninth aspects, a first portion of the third TCI field indicates one or more TCI states for the PDSCH, and a second portion of the third TCI field includes information associated with the one or more other TCI states

In an eleventh aspect, alone or in combination with one or more of the first through tenth aspects, the information associated with the one or more other TCI states includes a bit that indicates whether the pair of TCI states, or the one or more other TCI states, should be used after the second time.

In a twelfth aspect, alone or in combination with one or more of the first through eleventh aspects, the one or more other TCI states are determined based at least in part on a lowest codepoint that does not correspond to the pair of TCI states.

In a thirteenth aspect, alone or in combination with one or more of the first through twelfth aspects, process 1400 includes transmitting a radio resource control message, a medium access control message, or other DCI that indicates the one or more other TCI states.

In a fourteenth aspect, alone or in combination with one or more of the first through thirteenth aspects, the information associated with the one or more other TCI states indicates a first plurality of codepoints indicating the pair of TCI states, and a second plurality of codepoints indicating the one or more other TCI states.

In a fifteenth aspect, alone or in combination with one or more of the first through fourteenth aspects, the one or more other TCI states are determined based at least in part on a lowest four codepoints that do not correspond to the pair of TCI states.

In a sixteenth aspect, alone or in combination with one or more of the first through fifteenth aspects, process 1400 includes transmitting a radio resource control message, a medium access control message, or other DCI that indicates one or more codepoints for determining the one or more other TCI states.

In a seventeenth aspect, alone or in combination with one or more of the first through sixteenth aspects, process 1400 includes receiving, from a UE, capability information associated with the UE receiving the first DCI, having the first TCI field, and the second DCI, having the second TCI field.

Although FIG. 14 shows example blocks of process 1400, in some aspects, process 1400 may include additional blocks, fewer blocks, different blocks, or differently arranged blocks than those depicted in FIG. 14. Additionally. or alternatively. two or more of the blocks of process 1400 may be performed in parallel.

FIG. 15 is a diagram of an example apparatus 1500 for wireless communication. The apparatus 1500 may be a UE, or a UE may include the apparatus 1500. In some aspects, the apparatus 1500 includes a reception component 1502 and a transmission component 1504, which may be in communication with one another (for example, via one or more buses and/or one or more other components). As shown, the apparatus 1500 may communicate with another apparatus 1506 (such as a UE, a network node, a base station, or another wireless communication device) using the reception component 1502 and the transmission component 1504. As further shown, the apparatus 1500 may include the communication manager 140. The communication manager 140 may include a determination component 1508, among other examples.

In some aspects, the apparatus 1500 may be configured to perform one or more operations described herein in connection with FIGS. 7-12. Additionally, or alternatively, the apparatus 1500 may be configured to perform one or more processes described herein, such as process 1300 of FIG. 13. In some aspects, the apparatus 1500 and/or one or more components shown in FIG. 15 may include one or more components of the UE described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1506. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, a modem, a demodulator, a MIMO detector, a receive processor, a controller/processor, a memory, or a combination thereof, of the UE described in connection with FIG. 2.

The transmission component 1504 may transmit communications, such as reference signals, control information, data communications, or a combination thereof, to the apparatus 1506. In some aspects, one or more other components of the apparatus 1500 may generate communications and may provide the generated communications to the transmission component 1504 for transmission to the apparatus 1506. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1506. In some aspects, the transmission component 1504 may include one or more antennas, a modem, a modulator, a transmit MIMO processor, a transmit processor, a controller/processor, a memory, or a combination thereof, of the UE described in connection with FIG. 2. In some aspects, the transmission component 1504 may be co-located with the reception component 1502 in a transceiver.

The reception component 1502 may receive first DCI having a first TCI field that indicates a pair of TCI states to be used after a first time. The reception component 1502 may receive second DCI having a second TCI field that indicates a selected one or more TCI states, of the pair of TCI states, to be used for a PDSCH.

The reception component 1502 may receive a third DCI having a third TCI field that indicates to use one or more other TCI states after a second time.

The determination component 1508 may determine the one or more other TCI states based at least in part on a lowest codepoint that does not correspond to the pair of TCI states.

The determination component 1508 may determine the one or more other TCI states based at least in part on receiving a radio resource control message, a medium access control message, or other DCI that indicates the one or more other TCI states.

The determination component 1508 may determine the one or more other TCI states based at least in part on a lowest four codepoints that do not correspond to the pair of TCI states.

The determination component 1508 may determine the one or more other TCI states based at least in part on one or more codepoints that are indicated in a radio resource control message, a medium access control message, or other DCI.

The determination component 1508 may determine that the third DCI is scheduling DCI, if the third DCI has DCI format 1_1 or DCI format 1_2; the third DCI schedules a physical downlink shared channel (PDSCH); and the scheduled PDSCH is received after a beam indication from the first DCI is applied, the third DCI is received after the beam indication from the first DCI is applied, or the third DCI is received in a physical downlink control channel (PDCCH) monitoring occasion that is after a PDCCH monitoring occasion for the first DCI.

The transmission component 1504 may transmit capability information associated with receiving the first DCI, having the first TCI field, and the second DCI, having the second TCI field.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

FIG. 16 is a diagram of an example apparatus 1600 for wireless communication. The apparatus 1600 may be a network node, or a network node may include the apparatus 1600. In some aspects, the apparatus 1600 includes a reception component 1602 and a transmission component 1604, which may be in communication with one another (for example, via one or more buses and/or one or more other components). As shown, the apparatus 1600 may communicate with another apparatus 1606 (such as a UE, a network node, a base station, or another wireless communication device) using the reception component 1602 and the transmission component 1604. As further shown, the apparatus 1600 may include the communication manager 150. The communication manager 150 may include a configuration component 1608, among other examples.

In some aspects, the apparatus 1600 may be configured to perform one or more operations described herein in connection with FIGS. 7-12. Additionally, or alternatively, the apparatus 1600 may be configured to perform one or more processes described herein, such as process 1400 of FIG. 14. In some aspects, the apparatus 1600 and/or one or more components shown in FIG. 16 may include one or more components of the base station described in connection with FIG. 2. Additionally, or alternatively, one or more components shown in FIG. 16 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1602 may receive communications, such as reference signals, control information, data communications, or a combination thereof, from the apparatus 1606. The reception component 1602 may provide received communications to one or more other components of the apparatus 1600. In some aspects, the reception component 1602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1600. In some aspects, the reception component 1602 may include one or more antennas, a modem, a demodulator, a MIMO detector, a receive processor, a controller/processor, a memory, or a combination thereof, of the base station described in connection with FIG. 2.

The transmission component 1604 may transmit communications, such as reference signals, control information, data communications, or a combination thereof, to the apparatus 1606. In some aspects, one or more other components of the apparatus 1600 may generate communications and may provide the generated communications to the transmission component 1604 for transmission to the apparatus 1606. In some aspects, the transmission component 1604 may perform signal processing on the generated communications (such as filtering, amplification, modulation, digital-to-analog conversion, multiplexing, interleaving, mapping, or encoding, among other examples), and may transmit the processed signals to the apparatus 1606. In some aspects, the transmission component 1604 may include one or more antennas, a modem, a modulator, a transmit MIMO processor, a transmit processor, a controller/processor, a memory, or a combination thereof, of the base station described in connection with FIG. 2. In some aspects, the transmission component 1604 may be co-located with the reception component 1602 in a transceiver.

The transmission component 1604 may transmit first DCI having a first TCI field that indicates a pair of TCI states to be used after a first time. The transmission component 1604 may transmit second DCI having a second TCI field that indicates a selected one or more TCI states, of the pair of TCI states, to be used for a PDSCH.

The transmission component 1604 may transmit third DCI having a third TCI field that indicates to use one or more other TCI states after a second time.

The transmission component 1604 may transmit a radio resource control message, a medium access control message, or other DCI that indicates the one or more other TCI states.

The transmission component 1604 may transmit a radio resource control message, a medium access control message, or other DCI that indicates one or more codepoints for determining the one or more other TCI states.

The reception component 1602 may receive, from a UE, capability information associated with the UE receiving the first DCI, having the first TCI field, and the second DCI, having the second TCI field.

The configuration component 1608 may configure the UE 120 with information, such as the TCI state information described above in connection with reference numbers 710, 715, and 725, among other examples.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

The following provides an overview of some Aspects of the present disclosure:

Aspect 1: A method of wireless communication performed by a user equipment (UE), comprising: receiving first downlink control information (DCI) having a first transmission configuration indicator (TCI) field that indicates a pair of TCI states to be used after a first time; and receiving second DCI having a second TCI field that indicates a selected one or more TCI states, of the pair of TCI states, to be used for a physical downlink shared channel (PDSCH).

Aspect 2: The method of Aspect 1, wherein the first DCI is beam indication DCI that does not schedule the PDSCH, and the second DCI is scheduling DCI that schedules the PDSCH.

Aspect 3: The method of any of Aspects 1-2, wherein the second TCI field indicates to use a first TCI state, a second TCI state, or both the first TCI state and the second TCI state, of the pair of TCI states, for communicating the information.

Aspect 4: The method of any of Aspects 1-3, wherein the second TCI field indicates an order of the TCI states, of the pair of TCI states, for communicating the information.

Aspect 5: The method of any of Aspects 1-4, wherein the one or more TCI states, and an order of the one or more TCI states, are indicated in a two most significant bits, or a two least significant bits, of the second TCI field.

Aspect 6: The method of any of Aspects 1-5, wherein the one or more TCI states, and an order of the one or more TCI states, are indicated in a first four codepoints, or a last four codepoints, of the second TCI field.

Aspect 7: The method of any of Aspects 1-6, further comprising receiving a third DCI having a third TCI field that indicates to use one or more other TCI states after a second time.

Aspect 8: The method of Aspect 7, wherein the third DCI is beam indication DCI that does not schedule the PDSCH.

Aspect 9: The method of Aspect 8, wherein the one or more other TCI states are determined based at least in part on a mapping, associated with the first DCI, between a plurality of bits of the third TCI field and a plurality of possible TCI states.

Aspect 10: The method of Aspect 7, wherein the third DCI is beam indication DCI that schedules the PDSCH.

Aspect 11: The method of Aspect 10, wherein a first portion of the third TCI field indicates one or more TCI states for the PDSCH, and a second portion of the third TCI field includes information associated with the one or more other TCI states.

Aspect 12: The method of Aspect 11, wherein the information associated with the one or more other TCI states includes a bit that indicates whether the pair of TCI states, or the one or more other TCI states, should be used after the second time.

Aspect 13: The method of Aspect 12, further comprising determining the one or more other TCI states based at least in part on a lowest codepoint that does not correspond to the pair of TCI states.

Aspect 14: The method of Aspect 12, further comprising determining the one or more other TCI states based at least in part on receiving a radio resource control message, a medium access control message, or other DCI that indicates the one or more other TCI states.

Aspect 15: The method of Aspect 11, wherein the information associated with the one or more other TCI states indicates a first plurality of codepoints indicating the pair of TCI states, and a second plurality of codepoints indicating the one or more other TCI states.

Aspect 16: The method of Aspect 15, further comprising determining the one or more other TCI states based at least in part on a lowest four codepoints that do not correspond to the pair of TCI states.

Aspect 17: The method of Aspect 15, further comprising determining the one or more other TCI states based at least in part on one or more codepoints that are indicated in a radio resource control message, a medium access control message, or other DCI.

Aspect 18: The method of Aspect 7, further comprising determining that the third DCI is scheduling DCI, if: the third DCI has DCI format 1_1 or DCI format 1_2; the third DCI schedules the PDSCH; and the scheduled PDSCH is received after a beam indication from the first DCI is applied, the third DCI is received after the beam indication from the first DCI is applied, or the third DCI is received in a physical downlink control channel (PDCCH) monitoring occasion that is after a PDCCH monitoring occasion for the first DCI.

Aspect 19: The method of any of Aspects 1-18, further comprising transmitting capability information associated with receiving the first DCI, having the first TCI field, and the second DCI, having the second TCI field.

Aspect 20: A method of wireless communication performed by a network node, comprising: transmitting first downlink control information (DCI) having a first transmission configuration indicator (TCI) field that indicates a pair of TCI states to be used after a first time; and transmitting second DCI having a second TCI field that indicates a selected one or more TCI states, of the pair of TCI states, to be used for a physical downlink shared channel (PDSCH).

Aspect 21: The method of Aspect 20, wherein the first DCI is beam indication DCI that does not schedule the PDSCH, and the second DCI is scheduling DCI that schedules a PDSCH.

Aspect 22: The method of any of Aspects 20-21, wherein the second TCI field indicates to use a first TCI state, a second TCI state, or both the first TCI state and the second TCI state, of the pair of TCI states, for communicating the information.

Aspect 23: The method of any of Aspects 20-22, wherein the second TCI field indicates an order of the TCI states, of the pair of TCI states, for communicating the information.

Aspect 24: The method of any of Aspects 20-23, wherein the one or more TCI states, and an order of the one or more TCI states, are indicated in a two most significant bits, or a two least significant bits, of the second TCI field.

Aspect 25: The method of any of Aspects 20-24, wherein the one or more TCI states, and an order of the one or more TCI states, are indicated in a first four codepoints, or a last four codepoints, of the second TCI field.

Aspect 26: The method of any of Aspects 20-25, further comprising transmitting third DCI having a third TCI field that indicates to use one or more other TCI states after a second time.

Aspect 27: The method of Aspect 26, wherein the third DCI is beam indication DCI that does not schedule the PDSCH.

Aspect 28: The method of Aspect 27, wherein the one or more other TCI states are determined based at least in part on a mapping, associated with the first DCI, between a plurality of bits of the third TCI field and a plurality of possible TCI states.

Aspect 29: The method of Aspect 26, wherein the third DCI is beam indication DCI that schedules the PDSCH.

Aspect 30: The method of Aspect 29, wherein a first portion of the third TCI field indicates one or more TCI states for the PDSCH, and a second portion of the third TCI field includes information associated with the one or more other TCI states.

Aspect 31: The method of Aspect 30, wherein the information associated with the one or more other TCI states includes a bit that indicates whether the pair of TCI states, or the one or more other TCI states, should be used after the second time.

Aspect 32: The method of Aspect 31, wherein the one or more other TCI states are determined based at least in part on a lowest codepoint that does not correspond to the pair of TCI states.

Aspect 33: The method of Aspect 31, further comprising transmitting a radio resource control message, a medium access control message, or other DCI that indicates the one or more other TCI states.

Aspect 34: The method of Aspect 30, wherein the information associated with the one or more other TCI states indicates a first plurality of codepoints indicating the pair of TCI states, and a second plurality of codepoints indicating the one or more other TCI states.

Aspect 35: The method of Aspect 34, wherein the one or more other TCI states are determined based at least in part on a lowest four codepoints that do not correspond to the pair of TCI states.

Aspect 36: The method of Aspect 34, further comprising transmitting a radio resource control message, a medium access control message, or other DCI that indicates one or more codepoints for determining the one or more other TCI states.

Aspect 37: The method of any of Aspects 20-36, further comprising receiving, from a user equipment (UE), capability information associated with the UE receiving the first DCI, having the first TCI field, and the second DCI, having the second TCI field.

Aspect 38: An apparatus for wireless communication at a device, comprising a processor: memory coupled with the processor; and instructions stored in the memory and executable by the processor to cause the apparatus to perform the method of one or more of Aspects 1-19.

Aspect 39: A device for wireless communication, comprising a memory and one or more processors coupled to the memory, the one or more processors configured to perform the method of one or more of Aspects 1-19.

Aspect 40: An apparatus for wireless communication, comprising at least one means for performing the method of one or more of Aspects 1-19.

Aspect 41: A non-transitory computer-readable medium storing code for wireless communication, the code comprising instructions executable by a processor to perform the method of one or more of Aspects 1-19.

Aspect 42: A non-transitory computer-readable medium storing a set of instructions for wireless communication, the set of instructions comprising one or more instructions that, when executed by one or more processors of a device, cause the device to perform the method of one or more of Aspects 1-19.

Aspect 43: An apparatus for wireless communication at a device, comprising a processor; memory coupled with the processor; and instructions stored in the memory and executable by the processor to cause the apparatus to perform the method of one or more of Aspects 20-37.

Aspect 44: A device for wireless communication, comprising a memory and one or more processors coupled to the memory, the one or more processors configured to perform the method of one or more of Aspects 20-37.

Aspect 45: An apparatus for wireless communication, comprising at least one means for performing the method of one or more of Aspects 20-37.

Aspect 46: A non-transitory computer-readable medium storing code for wireless communication, the code comprising instructions executable by a processor to perform the method of one or more of Aspects 20-37.

Aspect 47: A non-transitory computer-readable medium storing a set of instructions for wireless communication, the set of instructions comprising one or more instructions that. when executed by one or more processors of a device, cause the device to perform the method of one or more of Aspects 20-37.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein. “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, operatively coupled to the memory, the one or more processors configured to:
receive first downlink control information (DCI) having a first transmission configuration indicator (TCI) field that indicates a pair of TCI states to be used after a first time; and
receive second DCI having a second TCI field that indicates a selected one or more TCI states, of the pair of TCI states, to be used for a physical downlink shared channel (PDSCH).

2. The apparatus of claim 1, wherein the first DCI is beam indication DCI that does not schedule the PDSCH, and the second DCI is scheduling DCI that schedules the PDSCH.

3. The apparatus of claim 1, wherein the second TCI field indicates to use a first TCI state, a second TCI state, or both the first TCI state and the second TCI state, of the pair of TCI states, for communicating the information.

4. The apparatus of claim 1, wherein the second TCI field indicates an order of the TCI states, of the pair of TCI states, for communicating the information.

5. The apparatus of claim 1, wherein the one or more TCI states, and an order of the one or more TCI states, are indicated in a two most significant bits, or a two least significant bits, of the second TCI field.

6. The apparatus of claim 1, wherein the one or more TCI states, and an order of the one or more TCI states, are indicated in a first four codepoints, or a last four codepoints, of the second TCI field.

7. The apparatus of claim 1, wherein the one or more processors are further configured to receive a third DCI having a third TCI field that indicates to use one or more other TCI states after a second time.

8. The apparatus of claim 7, wherein the third DCI is beam indication DCI that does not schedule the PDSCH.

9. The apparatus of claim 8, wherein the one or more other TCI states are determined based at least in part on a mapping, associated with the first DCI, between a plurality of bits of the third TCI field and a plurality of possible TCI states.

10. The apparatus of claim 7, wherein the third DCI is beam indication DCI that schedules the PDSCH.

11. The apparatus of claim 10, wherein a first portion of the third TCI field indicates one or more TCI states for the PDSCH, and a second portion of the third TCI field includes information associated with the one or more other TCI states.

12. The apparatus of claim 11, wherein the information associated with the one or more other TCI states includes a bit that indicates whether the pair of TCI states, or the one or more other TCI states, should be used after the second time.

13. The apparatus of claim 12, wherein the one or more processors are further configured to determine the one or more other TCI states based at least in part on a lowest codepoint that does not correspond to the pair of TCI states.

14. The apparatus of claim 11, wherein the information associated with the one or more other TCI states indicates a first plurality of codepoints indicating the pair of TCI states, and a second plurality of codepoints indicating the one or more other TCI states.

15. The apparatus of claim 14, wherein the one or more processors are further configured to determine the one or more other TCI states based at least in part on a lowest four codepoints that do not correspond to the pair of TCI states.

16. An apparatus for wireless communication at a network node, comprising:
a memory; and
one or more processors, operatively coupled to the memory, the one or more processors configured to:
transmit first downlink control information (DCI) having a first transmission configuration indicator (TCI) field that indicates a pair of TCI states to be used after a first time; and
transmit second DCI having a second TCI field that indicates a selected one or more TCI states, of the pair of TCI states, to be used for a physical downlink shared channel (PDSCH).

17. The apparatus of claim 16, wherein the first DCI is beam indication DCI that does not schedule the PDSCH, and the second DCI is scheduling DCI that schedules the PDSCH.

18. The apparatus of claim 16, wherein the second TCI field indicates to use a first TCI state, a second TCI state, or both the first TCI state and the second TCI state, of the pair of TCI states, for communicating the information.

19. The apparatus of claim 16, wherein the second TCI field indicates an order of the TCI states, of the pair of TCI states, for communicating the information.

20. The apparatus of claim 16, wherein the one or more TCI states, and an order of the one or more TCI states, are indicated in a two most significant bits, or a two least significant bits, of the second TCI field.

21. The apparatus of claim 16, wherein the one or more TCI states, and an order of the one or more TCI states, are indicated in a first four codepoints, or a last four codepoints, of the second TCI field.

22. The apparatus of claim 16, wherein the one or more processors are further configured to transmit third DCI having a third TCI field that indicates to use one or more other TCI states after a second time.

23. The apparatus of claim 22, wherein the third DCI is beam indication DCI that does not schedule the PDSCH.

24. The apparatus of claim 23, wherein the one or more other TCI states are determined based at least in part on a mapping, associated with the first DCI, between a plurality of bits of the third TCI field and a plurality of possible TCI states.

25. The apparatus of claim 22, wherein the third DCI is beam indication DCI that schedules the PDSCH.

26. The apparatus of claim 25, wherein a first portion of the third TCI field indicates one or more TCI states for the PDSCH, and a second portion of the third TCI field includes information associated with the one or more other TCI states.

27. The apparatus of claim 26, wherein the information associated with the one or more other TCI states includes a bit that indicates whether the pair of TCI states, or the one or more other TCI states, should be used after the second time.

28. The apparatus of claim 26, wherein the information associated with the one or more other TCI states indicates a first plurality of codepoints indicating the pair of TCI states, and a second plurality of codepoints indicating the one or more other TCI states.

29. A method of wireless communication performed by a user equipment (UE), comprising:
receiving first downlink control information (DCI) having a first transmission configuration indicator (TCI) field that indicates a pair of TCI states to be used after a first time; and
receiving second DCI having a second TCI field that indicates a selected one or more TCI states, of the pair of TCI states, to be used for a physical downlink shared channel (PDSCH).

30. The method of claim 29, wherein the first DCI is beam indication DCI that does not schedule the PDSCH, and the second DCI is scheduling DCI that schedules the PDSCH.

31. The method of claim 29, wherein the second TCI field indicates to use a first TCI state, a second TCI state, or both the first TCI state and the second TCI state, of the pair of TCI states, for communicating the information.

32. The method of claim 29, wherein the second TCI field indicates an order of the TCI states, of the pair of TCI states, for communicating the information.

33. A method of wireless communication performed by a network node, comprising:
transmitting first downlink control information (DCI) having a first transmission configuration indicator (TCI) field that indicates a pair of TCI states to be used after a first time; and
transmitting second DCI having a second TCI field that indicates a selected one or more TCI states, of the pair of TCI states, to be used for a physical downlink shared channel (PDSCH).

34. The method of claim 33, wherein the first DCI is beam indication DCI that does not schedule the PDSCH, and the second DCI is scheduling DCI that schedules the PDSCH.

35. The method of claim 33, wherein the second TCI field indicates to use a first TCI state, a second TCI state, or both the first TCI state and the second TCI state, of the pair of TCI states, for communicating the information.
